(19) United States
(12) Patent Application Publication
(10) Pub. No.: US 2019/0012373 A1
(43) Pub. Date: Jan. 10, 2019

(54) CONVERSATIONAL/MULTI-TURN QUESTION UNDERSTANDING USING WEB INTELLIGENCE

(71) Applicant: Microsoft Technology Licensing, LLC, Redmond, WA (US)

(72) Inventors: Manish Malik, Cupertino, CA (US); Jiarui Ren, Redwood City, CA (US); Qifa Ke, Cupertino, CA (US)

(73) Assignee: Microsoft Technology Licensing, LLC, Redmond, WA (US)

(21) Appl. No.: 15/645,529

(22) Filed: Jul. 10, 2017

(51) Int. Cl. G06F 17/30; G06F 17/27

(52) U.S. Cl. CPC G06F 17/30684; G06F 17/2785; G06F 17/274; G06F 17/30958; G06F 17/30696; G06F 17/30528; G06F 17/278

(57) ABSTRACT

Conversational or multi-turn question understanding using web intelligence is provided. An intelligent query understanding system is provided for receiving a context-dependent query from a user, obtaining contextual information related to the context-dependent query, and reformatting the context-dependent query as one or more reformulations based on the contextual information. The intelligent query understanding system is further operative to query a search engine with the one or more reformulations, receive one or more candidate results, and select a highest ranked reformulation based on the candidate results. The system can provide the highest ranked reformulation of the highest ranked reformulation as a response.

### BACKGROUND

As question-and-answer (QnA) technologies such as chatbots, digital personal assistants, conversational agents, speaker devices, and the like are becoming more prevalent, computing device users are increasingly interacting with their computing devices using natural language. For example, when using a computing device to search for information, users are increasingly using conversational searches, rather than traditional keyword or keyphrase query approaches. In a conversational search, a user may formulate a question or query in such a way that the user's intent is explicitly defined. For example, a user may ask, “What is the weather forecast for today in Seattle, Wash.?” In this question, there is no ambiguity in identifying the entities in the query: weather forecast, today, Seattle, Wash., nor in understanding the intent behind the query.

Alternatively, a user's query may be context-dependent, where the user asks a question in such a way that contextual information is needed to infer the user's intent. For example, a user may use a limited number of words to try to find information about a topic, and a search engine or other QnA technology is challenged with attempting to understand the intent behind that search and with trying to find web pages or other results in response. As an example, a user may ask, “Will it rain tomorrow?” In this example, the system receiving the query may need to use contextual information, such as the user's current location, to help understand the user's intent.

As another example, a user may ask a question that includes an indefinite pronoun referring to one or more unspecified objects, beings, or places, and the entity to which the indefinite pronoun is referring may not be specified in a current query, but may be mentioned in a previous query or answer. For example, a user may ask, “Who played R3D3 in Star Saga Episode V,” followed by “Who directed it,” by which the user's intent is to know “who directed Star Saga Episode V?” Humans are typically able to easily understand and relate back to contextual entity information mentioned earlier in a conversation. However, search engines or other QnA systems generally struggle with this, particularly in longer or multi-turn conversations, and may not be able to adequately reformulate multi-turn questions or may treat each search as if it is unconnected to the previous one.

As can be appreciated, users can become frustrated when a QnA system is unable to handle multi-turn conversations. When a system is unable to understand a user's intent, the user may have to re-ask a question in another way in an attempt to get the answer desired. Not only is this inefficient for the user, but processing additional queries also involves additional computer processing and network bandwidth usage.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Aspects are directed to a system, method, and computer readable storage device for providing conversational or multi-turn question understanding using web intelligence. According to aspects, an intelligent query understanding system is able to understand a user's intent for a context-dependent question, and to provide a semantically-relevant response to the user in a conversational manner, thus providing an improved user experience and improved user interaction efficiency. As used herein, the term “context-dependent” is used to define a question or query that does not comprise a direct reference or for which additional context is needed for answering the question. For example, the additional context can be in a previous question or answer in a conversation or in the user's environment (e.g., user preferences, the time of day, the user's location, the user's current activity). The intelligent query understanding system is provided for receiving a context-dependent query from a user, obtaining contextual information related to the context-dependent query, and reformatting the context-dependent query as one or more reformulations based on the contextual information. The intelligent query understanding system is further operative to query a search engine with the one or more reformulations, receive one or more candidate results, and return a response to the user based on a highest ranked reformulation.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1A is a block diagram illustrating an example environment in which an intelligent query understanding system can be implemented for providing conversational or multi-turn question understanding;

FIG. 1B is a block diagram illustrating components and functionalities of the intelligent query understanding system;

FIG. 2 is an illustration of an example query and response session using aspects of the intelligent query understanding system;

FIG. 3 is a flowchart showing general stages involved in an example method for providing conversational or multi-turn question understanding;

FIG. 4 is a block diagram illustrating physical components of a computing device with which examples may be practiced;

FIGS. 5A and 5B are block diagrams of a mobile computing device with which aspects may be practiced; and

FIG. 6 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

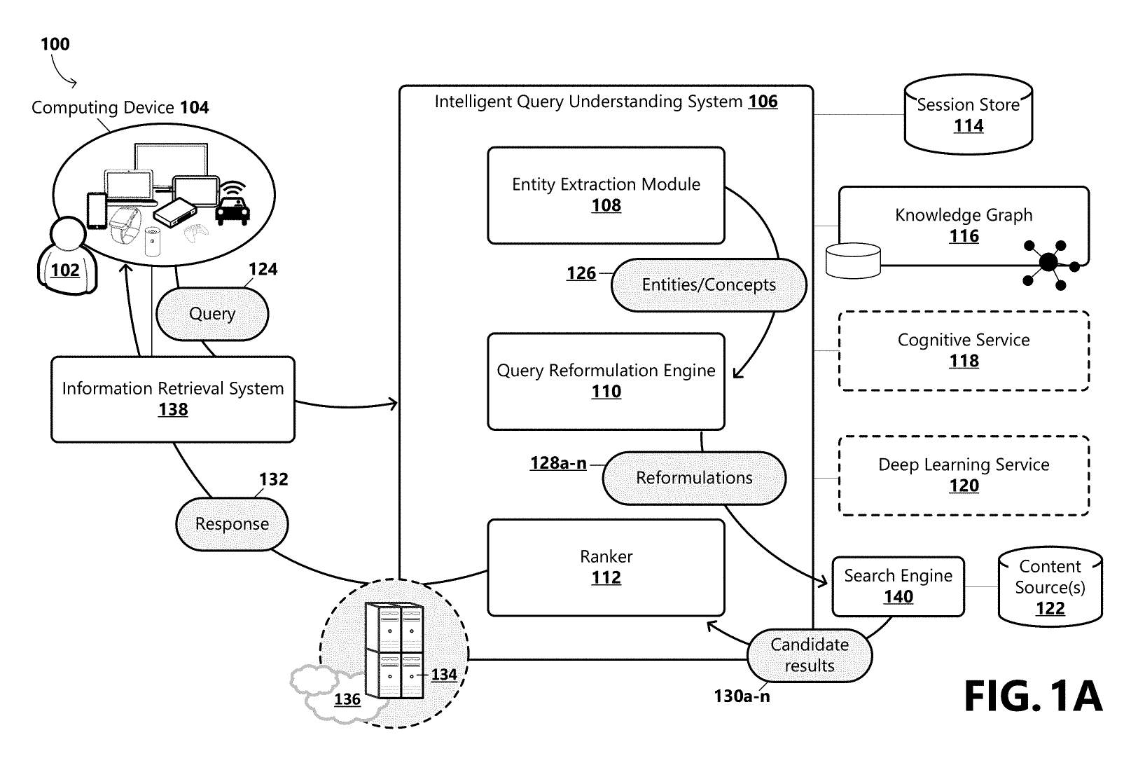

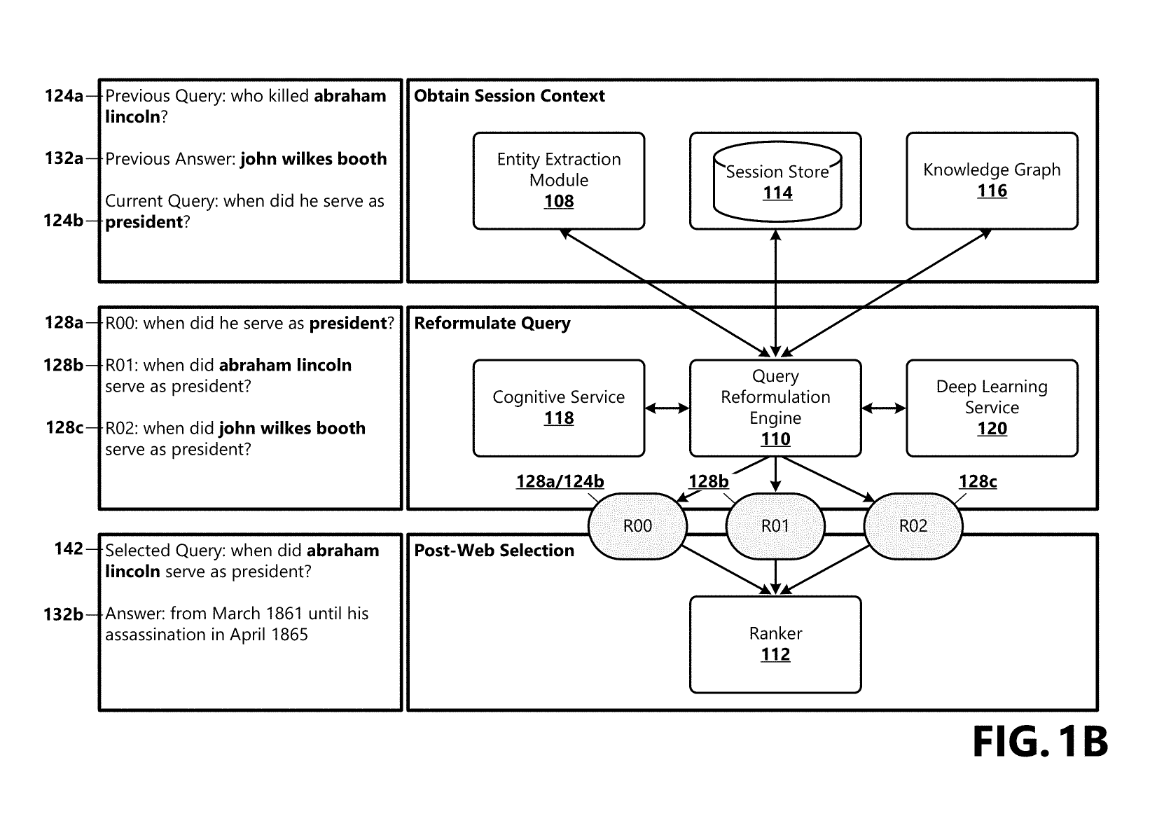

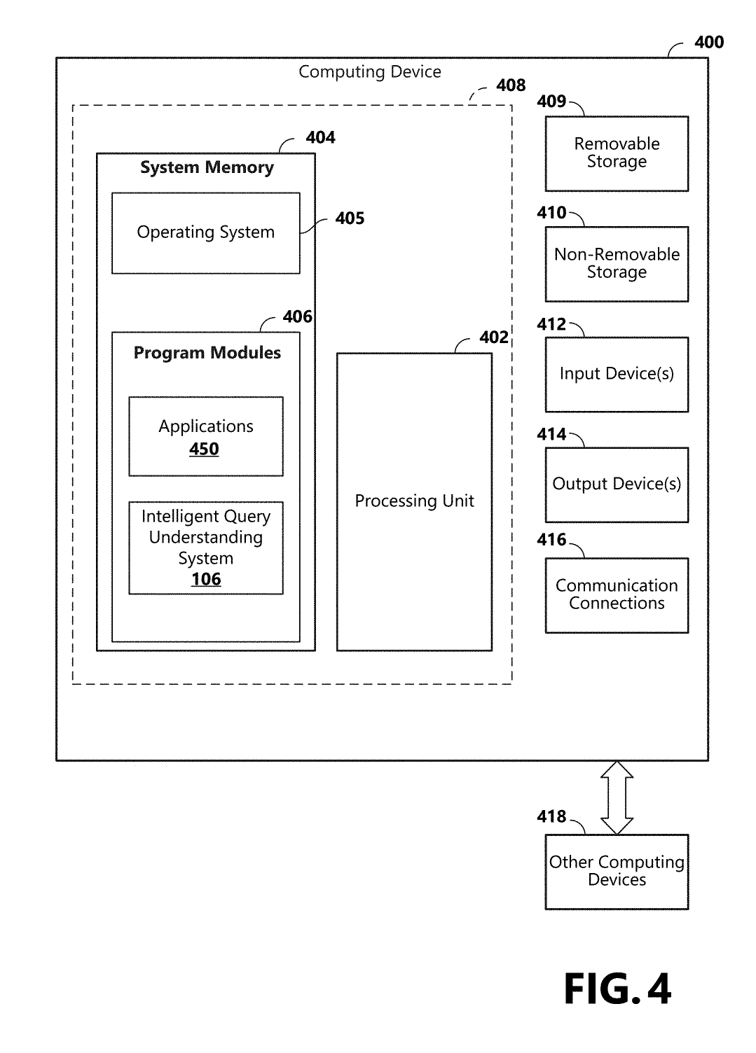

Aspects of the present disclosure are directed to a system, method, and computer readable storage device for providing an intelligent response in a conversation. FIG. 1A illustrates a block diagram of a representation of a computing environment 100 in which providing an intelligent conversational response may be implemented. As illustrated, the example environment 100 includes an intelligent query understanding system 106, operative to receive a query 124 from a user 102, understand the user's intent, and to provide an intelligent response 132 to the query. According to examples, a user 102 uses an information retrieval system 138 executed on a client computing device 104 or on a remote computing device or server computer 134 and communicatively attached to the computing device 104 through a network 136 or a combination of networks (e.g., a wide area network (e.g., the Internet), a local area network, a private network, a public network, a packet network, a circuit-switched network, a wired network, or a wireless network). The computing device 104 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, a speaker device, or other type of computing device). The hardware of these computing devices is discussed in greater detail in regards to FIGS. 4, 5A, 5B, and 6.

According to examples, the information retrieval system 138 can be embodied as one of various types of information retrieval systems, such as a web browser application, a digital personal assistant, a messaging application, a chat bot, or other type of question-and-answer system. As should be appreciated, other types of information retrieval systems 138 are possible and are within the scope of the present disclosure. According to an aspect, the user 102 is enabled to specify criteria about an item or topic of interest, wherein the criteria are referred to as a search query 124. The search query 124 is typically expressed as a set of words that identify a desired entity or concept that one or more content items may contain. In some examples, the information retrieval system 138 employs a user interface (UI) by which the user 102 can submit a query 124 and by which a response 132 to the query, conversation dialog, or other information may be delivered to the user. In examples, the UI is configured to receive user inputs (e.g., questions, requests, commands) in the form of audio messages or text messages, and deliver responses 132 to the user 102 in the form of audio messages or displayable messages. In one example, the UI is implemented as a widget integrated with a software application, a mobile application, a website, or a web service employed to provide a computer-human interface for acquiring a query 124 and delivering a response 132 to the user 102. According to an example, when input is received via an audio message, the input may comprise user speech that is captured by a microphone of the computing device 104. Other input methods are possible and are within the scope of the present disclosure. For example, the computing device 104 is operative to receive input from the user, such as text input, drawing input, inking input, selection input, etc., via various input methods, such as those relying on mice, keyboards, and remote controls, as well as Natural User Interface (NUI) methods, which enable a user to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence.

According to an aspect, the information retrieval system 138 comprises or is operatively connected to the intelligent query understanding system 106. In some examples, the intelligent query understanding system 106 is exposed to the information retrieval system 138 as an API (application programming interface). In some examples, the intelligent query understanding system 106 is called by a question-and-answer system to reformulate a query to include a correct context, which then passes the reformulated query to the question-and-answer system for finding an answer to the query. According to an aspect, the intelligent query understanding system 106 comprises an entity extraction module 108, a query reformulation engine 110, and a ranker 112. In some examples, the intelligent query understanding system 106 comprises one or a plurality of computing devices 104 that are programmed to provide services in support of the operations of providing an intelligent conversational response responsive to a query. For example, the components of the intelligent query understanding system 106 can be located on a single computer (e.g., server computer 134), or one or more components of the intelligent query understanding system 106 can be distributed across a plurality of devices.

According to an aspect, the entity extraction module 108 is illustrative of a software module, system, or device operative to detect entities or concepts (referred to herein collectively as entities/concepts 126) in a query 124 and in previous queries and answers or responses to the previous queries in a conversation. When the intelligent query understanding system 106 receives a search query 124 (via the information retrieval system 138), the intelligent query understanding system 106 invokes the entity extraction module 108 for obtaining session context. For example, the entity extraction module 108 is operative to detect entities/concepts 126 in the current query 124 and if applicable, in previous queries and answers in a conversation. The entity extraction module 108 is further operative to detect or receive implicit information related to the query 124, such as information about the user 102 or the user's environment (e.g., user preferences, the time of day, the user's location, the user's current activity).

In some examples, the query 124 is formulated by the user 102 in such a way that the user's intent is explicitly defined in the query. For example, the query 124 includes one or more entities/concepts 126 that can be located and classified within a text string. According to an aspect, an object (e.g., person, place, or thing) about which data can be captured or stored is considered an entity. For example, in the question, “What is the weather forecast for today in Seattle, Wash.?,” “weather,” “forecast,” “today,” “Seattle,” and “Washington” may be identified as entities. According to another aspect, as used herein, a concept is defined as a word or term in a text string that has semantic meaning. For example, in the following conversation, “What is the tuition fee for full-time students at the University of Michigan?,” and subsequently, “What about part-time students?,” the words “University of Michigan” may be identified as an entity, and “full-time students” and “part-time students” may be identified as concepts.

In other examples, a received query 124 is context-dependent. As described above, as used herein, the term “context-dependent” is used to define a question or query that does not comprise a direct reference or for which additional context is needed for answering the question. For example, the additional context can be in a previous question or answer in a conversation or in the user's environment (e.g., user preferences, the time of day, the user's location, the user's current activity). In some examples, the query 124 does not include a direct reference (e.g., a first query “Star Saga Episode V,” followed by a second query “who is the director?”). In other examples, the query 124 includes one or more words or grammatical markings that make reference to an entity/concept 126 outside the context of the current query. For example, the query 124 can include an exophoric reference, wherein the exophoric reference is a pronoun or other word that refers to a subject that does not appear in the query. According to one example, the exophoric reference included in the query 124 refers to implicit information that involves using contextual information, such as the user's current location, the time of day, user preferences, the user's current activity, and the like to help understand the user intent or query intent. According to another example, a query 124 can be part of a conversation comprised of a plurality of queries 124 and at least one response 132, and can include an exophoric reference referring to entities mentioned earlier in the conversation. For example, the user 102 can ask, “How old is Queen Elizabeth?” in a first query, followed by “How tall is she?” in a second query in the same conversation, wherein the term “she” in the second query refers to “Queen Elizabeth” mentioned in the first query.

According to one aspect, contextual information related to a current query conversation session includes physical context data, such as the user's current location, the time of day, user preferences, or the user's current activity. Physical context data are stored in a session store 114. According to another aspect, contextual information related to a current query conversation session includes linguistic context data, such as entities/concepts 126 detected in previous queries 124 and responses 132 in a conversation. The session store 114 is further operative to store linguistic context data (e.g., entities/concepts 126 detected in previous queries 124 and responses 132 in a conversation). The entity extraction module 108 is operative to communicate with the session store 114 to retrieve contextual information related to the current conversation. In some examples, one or more pieces of the contextual information are used to understand the user intent or query intent. According to some aspects, the entity extraction module 108 is in communication with one or more cognitive services 118, which operate to provide language understanding services for detecting entities/concepts 126 in a query 124. In some examples, the one or more cognitive services 118 can provide language understanding services for reformulating a current query. In some examples, the one or more cognitive services 118 are APIs.

In some examples, the entity extraction module 108 is in communication with a knowledge graph 116. When one or more entities/concepts 126 are identified in a query 124, the entity extraction module 108 queries the knowledge graph 116 for properties of the identified entities/concepts. Consider as an example the multi-turn conversation including a first query “who acted as R3D3 in Star Saga Episode V,” followed by the answer “Kent Barker,” followed by a second query “who directed it.” The entity extraction module 108 may query the knowledge graph 116 for the entities “R3D3,” “Star Saga Episode V,” “directed,” and “Kent Barker” (the answer to the first query). Results of the knowledge graph query can help provide additional context to the current query. The knowledge graph 116 is illustrative of a repository of entities and relationships between entities. In the knowledge graph 116, entities/concepts 126 are represented as nodes, and attributes and relationships between entities/concepts are represented as edges connecting the nodes. Thus, the knowledge graph 116 provides a structured schematic of entities and their relationships to other entities. According to examples, edges between nodes can represent an inferred relationship or an explicit relationship. According to an aspect, the knowledge graph 116 is continually updated with content mined from a plurality of content sources 122 (e.g., web pages or other networked data stores).

According to an aspect, the entity extraction module 108 is operative to pass entities/concepts 126 identified in the current query 124 to the query reformulation engine 110. In some examples, the entity extraction module 108 is further operative to pass properties associated with the identified entities/concepts to the query reformulation engine 110. In some examples, the entity extraction module 108 is further operative to pass contextual information related to the current conversation session to the query reformulation engine 110. The query reformulation engine 110 is illustrative of a software module, system, or device operative to receive the entities/concepts 126, properties of the entities/concepts, and contextual information from the entity extraction module 108, and reformat the current query into a plurality of reformulated queries (herein referred to as reformulations 128a-n (collectively 128)). According to an aspect, the reformulations 128 are single-turn queries that do not depend on information in a previous query for understanding the user intent or query intent.

In some examples, the query reformulation engine 110 operates to reformat the current query 124 based on the contextual information. As described above, in some examples, the contextual information includes physical context, such as user preferences, the time of day, the user's location, the user's current activity, etc. In other examples, the contextual information includes linguistic context, such as entities/concepts 126 identified in previous queries or responses 132 of the current conversation. According to some aspects, the query reformulation engine 110 is in communication with a deep learning service 120 that operates to provide a machine learning model for determining possible reformulations of the current query 124. In some examples, the deep learning service 120 is an API exposed to the intelligent query understanding system 106.

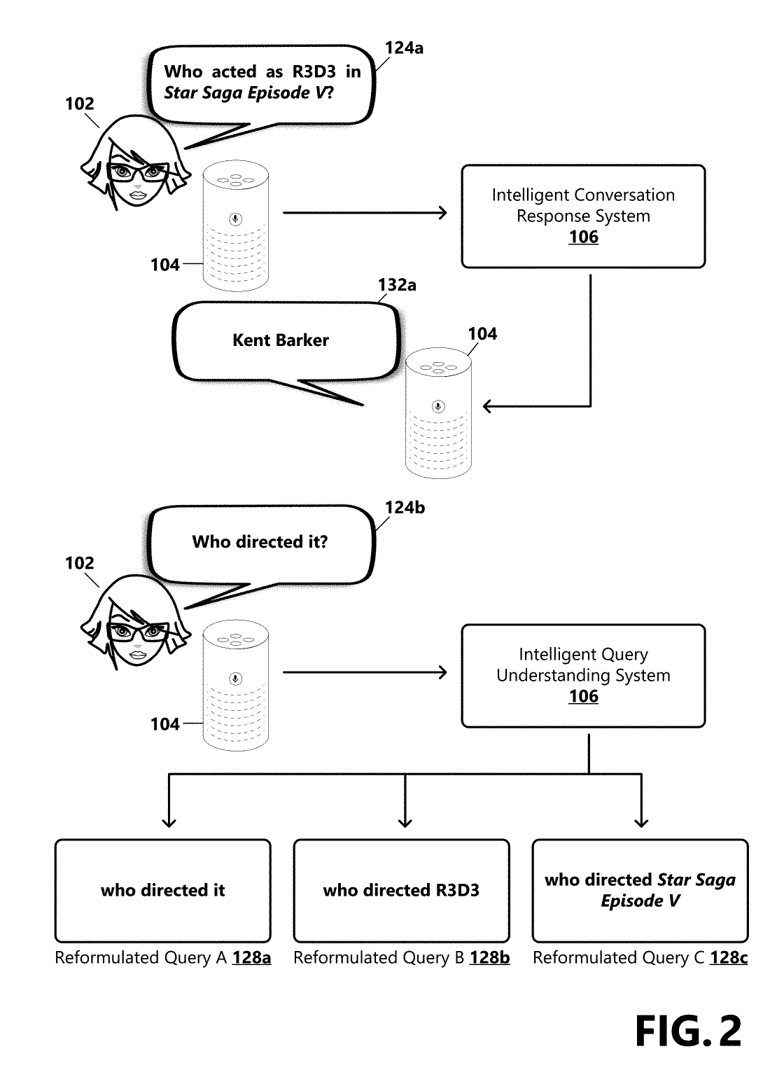

An example multi-turn conversation intelligent query understanding system and determined reformulations 128 based on contextual information are illustrated in FIG. 2. With reference now to FIG. 2, the user 102 submits a first query 124a, “who acted as R3D3 in Star Saga Episode V?,” and “Kent Barker” is provided as an answer or response 132a to the first query. Subsequently, the user 102 asks, “who directed it?” in a second and current query 124b. According to an aspect, the query reformulation engine 110 uses one or more pieces of contextual information, and reformats the current query 124b into a plurality of reformulations 128a-c based on one or more pieces of contextual information. According to one aspect, one of the plurality of reformulations 128a is the current query 124b (e.g., “who directed it?”). As illustrated, based on contextual information, other reformulations 128b,c include “who directed R3D3” and “who directed Star Saga Episode V.”

With reference again to FIG. 1A, after generating possible reformulations 128 for the current query 124, the intelligent query understanding system 106 is operative to query a search engine 140 with the reformulations 128. For example, the intelligent query understanding system 106 fires each of the reformulations 128 as separate queries to the search engine 140. According to an aspect, the search engine 140 mines data available in various content sources 122 (e.g., web pages, databases, open directories, or other networked data stores). Responsive to the search engine queries, a plurality of candidate results 130a-n (collectively 130) are provided to the intelligent query understanding system 106.

The ranker 112 is illustrative of a software module, system, or device operative to receive the plurality of candidate results 130 (e.g., web documents, URLs), and rank the reformulations 128 based on post web signals. For example, the ranker 112 analyzes each candidate result 130 for determining a relevance score. In some examples, the relevance score indicates a measure of quality of documents or URLs to an associated reformulation 128, wherein a top-ranked reformulation has candidate results 130 that make semantic sense. For example, in the example illustrated in FIG. 2, the “who directed it” reformulation 128a will likely not return high-quality documents. Likewise, the “who directed R3D3” reformulation 128b will likely not return high-quality results, given that R3D3 is a character and not a movie, and thus asking who directed the character R3D3 does not make semantic sense. The “who directed Star Saga Episode V” reformulation 128c does make semantic sense and will likely produce high-quality results that include Marrvin Kushner as the director of the movie Star Saga Episode V.

In some examples, consistency of candidate results 130 for a given reformulation 128 is analyzed and used as a factor in determining the relevance score for the reformulation. For example, a high-quality or top-ranked reformulation will have a plurality of candidate results 130 that are generally consistent. In the multi-turn conversation example mentioned earlier where the user 102 asks “how old is Queen Elizabeth?” in a first query, followed by “how tall is she?” in a second query in the same conversation, a first reformulation 128 of “how tall is she” is likely to produce inconsistent results, and a second reformulation 128 of “how tall is Queen Elizabeth” is likely to produce generally consistent results that make semantic sense. Accordingly, the second reformulation 128 will have a higher relevance score than the first reformulation. According to an aspect, a highest-ranked reformulation 128 is selected based on the relevance score, and a response 132 to the current query 124 is generated and provided to the user 102 via the information retrieval system 138 used to provide the query. For example, the response 132 includes an answer generated from one or more candidate results 130 responsive to the highest-ranked reformulation 128. According to an aspect, the response 132 is provided to the user 102 via the communication channel via which the query was received (e.g., displayed in textual form in a graphical user interface (GUI) or spoken in an audible response played back via speaker(s) of the computing device or connected to the computing device).

FIG. 1B is a block diagram illustrating components and functionalities of the intelligent query understanding system 106. Referring now to FIG. 1B, a current query 124b (“when did he serve as president”) is received, which the entity extraction module 108 analyzes for detecting entities/concepts 126 and for obtaining session context. For example, the entity extraction module 108 may detect and extract “president” from the current query 124b. Further, the entity extraction module 108 obtains contextual information related to the current query 124b, such as entities/concepts 126 detected in previous queries 124a and previous responses 132a and/or physical context data (e.g., user preferences, the user's current location, the time of day, the user's current activity) from the session store 114. For example, the extraction module 108 may obtain “abraham lincoln” and “john wilkes booth” from the previous query 124a and answer or result 132a. The entity extraction module 108 is further operative to query the knowledge graph 116 for properties of the entities/concepts 126, such as that Abraham Lincoln is a male entity, John Wilkes Booth is a male entity, and other factoids associated with Abraham Lincoln and John Wilkes Booth.

Next, the query reformulation engine 110 reformulates the current query 124b. In some examples, one or more cognitive services 118 are used to provide language understanding services and a deep learning service 120 is used for providing a machine learning model for reformulating the current query 124b into a plurality of single-turn reformulations 128. According to an aspect, one reformulation 128a is the current query 124b in an un-reformulated state (i.e., R00 128a is not reformulated). That is, one reformulation 128a is the current query 124b in its original state or form. Each of the plurality of reformulations 128 are fired as separate queries to a search engine 140. The ranker 112 analyzes and ranks the reformulations 128 based on post web signals that indicate a measure of quality of search result documents or URLs to an associated reformulation 128, wherein a top-ranked reformulation makes semantic sense, has candidate results 130 that make semantic sense and are generally consistent. In some examples, the top-ranked reformulation 142 is the current query 124b in its original form, and accordingly, a determination can be made that the current query is not context-dependent. In some examples, the top-ranked reformulation 142 is provided as a response to an API query for understanding the current query 124b. In other examples, a top-ranked answer to the top-ranked reformulation 142 is provided as a response 132b to the current query 124b.

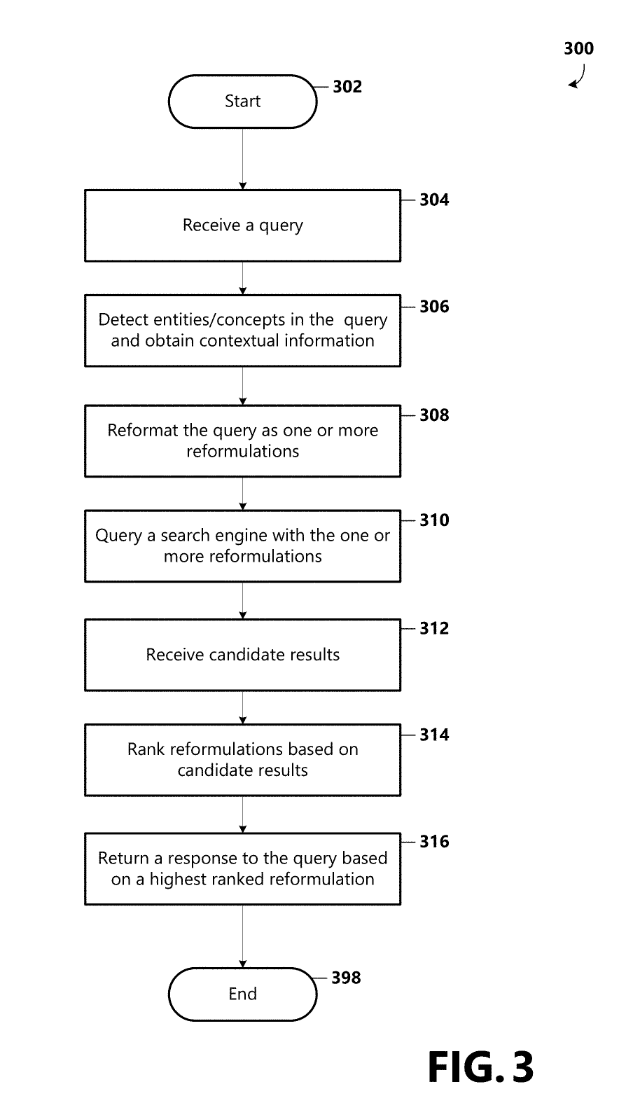

Having described an operating environment 100, components of the intelligent query understanding system 106, and a use case example with respect to FIGS. 1A, 1B, and 2, FIG. 3 is a flow chart showing general stages involved in an example method 300 for providing a conversational or multi-turn question understanding. With reference now to FIG. 3, the method 300 begins at START OPERATION 302, and proceeds to OPERATION 304, where a query 124 is received. For example, the user 102 provides a query to an information retrieval system 138 via textual input, spoken input, etc. According to an aspect, the query 124 is context-dependent, and the user intent or query intent is not explicitly defined. For example, the query 124 does not include a direct reference to an entity or concept, or includes an exophoric reference that refers to a subject that does not appear in the current query. In some examples, the query 124 is dependent on physical context data (e.g., user preferences, the user's current location, the time of day, the user's current activity). In other examples, the query 124 is dependent on linguistic context data included in a previous query or response 132 within the current multi-turn conversation. According to one example, the query 124 is not context-dependent and is treated as a standalone question.

The method 300 proceeds to OPERATION 306, where entities/concepts 126 in the current query 124 are detected and contextual information associated with the current conversation session is obtained. In detecting entities/concepts 126 in the current query 124, a cognitive service 118 can be used for language understanding. Further, a knowledge graph 116 can be used for obtaining properties of identified or detected entities/concepts 126 in the query. In some examples, physical context data can be stored in and collected from a session store 114. In other examples, the current query 124 is part of a conversation including at least one previous query and response 132, and linguistic context data including entities/concepts 126 included in the at least one previous query and response is collected.

The method 300 proceeds to OPERATION 308, where the current query 124 is reformatted into a plurality of reformulations 128 based on the contextual information. For example, a reformulation 128 can include an entity/concept 126 mentioned in a previous query or response in the current conversation session. According to an aspect, one reformulation 128 includes the original query 124 (i.e., one reformulation is the current query in its original form—not reformulated).

The method 300 proceeds to OPERATION 310, where a search engine 140 is queried with the plurality of reformulations 128. For example, each reformulation is provided as a separate search engine query. At OPERATION 312, a plurality of candidate results 130 are returned to the intelligent query understanding system 106. In some examples, a plurality of candidate results 130 are provided for each reformulation 128.

The method 300 continues to OPERATION 314, where the plurality of reformulations 128 are ranked based on a determined quality of their associated candidate results 130. For example, a relevance score for a particular reformulation 128 can be based in part on whether the reformulation makes semantic sense. As another example, a relevance score for a particular reformulation 128 can be based on the quality of the search results based on web intelligence. As another example, a relevance score for a particular reformulation 128 can be based in part on how consistent its associated candidate results 130 are. According to an aspect, a top-ranked reformulation 128 makes semantic sense, will have high quality results, and will have consistent information between search engine query candidate results 130.

At OPERATION 316, a highest-ranked reformulation 128 is selected, and a response 132 to the current query 124 is generated based on information in one or more of the candidate results 130 associated with the selected reformulation. In some examples, the original query (un-reformatted query 124) is selected as the best reformulation, for example, when it has strong signals form its search engine results. Accordingly, the query 124 can be treated as a standalone question or as a query that is not context-dependent, rather than a contextual or conversational question. The response 132 is then provided to the user 102 as an answer displayed in a GUI or provided in an audible format through one or more speakers of the computing device 104 or connected to the computing device. In some examples, the highest-ranked reformulation is provided in a response to another system, such as a question-and-answer system responsive to an API call. The method 300 ends at OPERATION 398.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are used for practicing aspects, described herein.

FIG. 4 is a block diagram illustrating physical components (i.e., hardware) of a computing device 400 with which examples of the present disclosure are be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes one or more components of the intelligent query understanding system 106. The operating system 405, for example, is suitable for controlling the operation of the computing device 400. Furthermore, aspects are practiced in conjunction with a graphics library, other operating systems, or any other application program, and is not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 (e.g., one or more components of the intelligent query understanding system 106) perform processes including, but not limited to, one or more of the stages of the method 300 illustrated in FIG. 3. According to an aspect, other program modules are used in accordance with examples and include applications 450 such as electronic mail and contacts applications, word processing applications, spreadsheet applications, database applications, slide presentation applications, drawing or computer-aided drafting application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

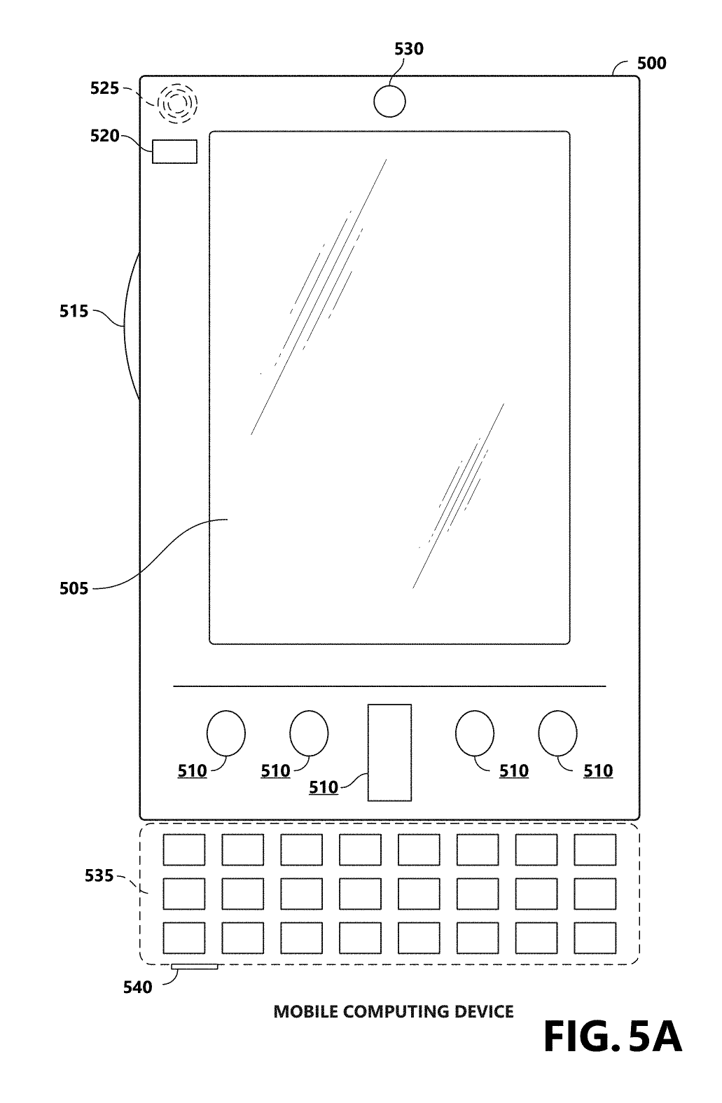

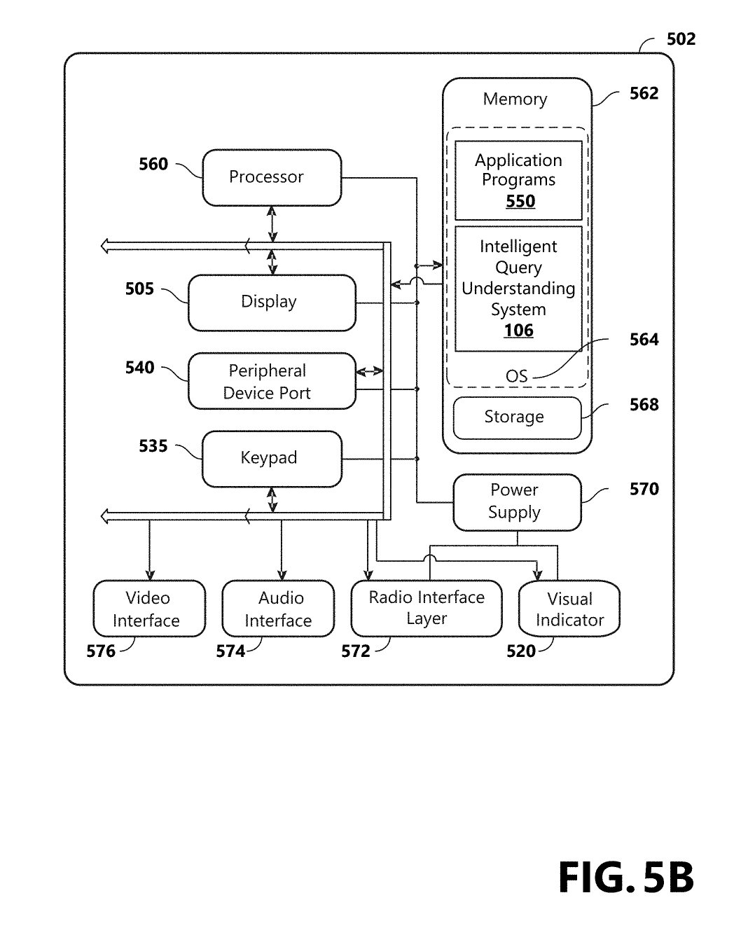

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or less input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, one or more components of the intelligent query understanding system 106 are loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 is stored locally on the mobile computing device 500, as described above. According to another aspect, the data is stored on any number of storage media that is accessible by the device via the radio 572 or via a wired connection between the mobile computing device 500 and a separate computing device associated with the mobile computing device 500, for example, a server computer in a distributed computing network, such as the Internet. As should be appreciated such data/information is accessible via the mobile computing device 500 via the radio 572 or via a distributed computing network. Similarly, according to an aspect, such data/information is readily transferred between computing devices for storage and use according to well-known data/information transfer and storage means, including electronic mail and collaborative data/information sharing systems.

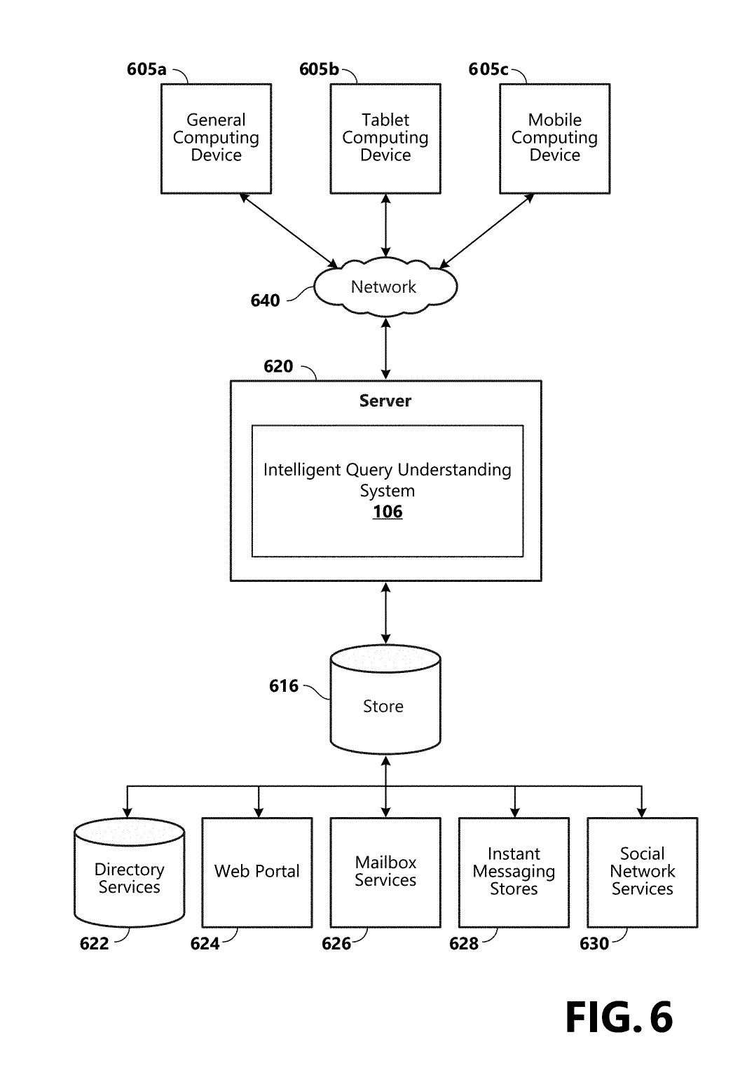

FIG. 6 illustrates one example of the architecture of a system for providing an intelligent response in a conversation, as described above. Content developed, interacted with, or edited in association with the intelligent query understanding system 106 is enabled to be stored in different communication channels or other storage types. For example, various documents may be stored using a directory service 622, a web portal 624, a mailbox service 626, an instant messaging store 628, or a social networking site 630. The intelligent query understanding system 106 is operative to use any of these types of systems or the like for providing an intelligent response in a conversation, as described herein. According to an aspect, a server 620 provides the intelligent query understanding system 106 to clients 605a,b,c. As one example, the server 620 is a web server providing the intelligent query understanding system 106 over the web. The server 620 provides the intelligent query understanding system 106 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for providing query understanding, comprising:
a processing unit; and
a memory, including computer readable instructions, which when executed by the processing unit is operable to:
receive a query;
obtain contextual information related to the query;
reformat the query as one or more reformulations based on the contextual information, wherein one of the one or more reformulations includes the query in its original form;
query a search engine with the one or more reformulations;
receive one or more candidate results; and
return a response to the query based on a highest ranked reformulation of the one or more reformulations.

2. The system of claim 1, wherein:
the query includes one or more words or grammatical markings that make reference to an entity/concept outside a context of the current query.

3. The system of claim 2, wherein:
the query is part of a conversation session or multi-turn question; and
the one or more words or grammatical markings refers to an entity/concept included in a previous query or response in the conversation session.

4. The system of claim 1, wherein in obtaining contextual information related to the query, the system is operative to obtain physical context data, wherein physical context data includes at least one of:
user preferences;
a current location of a user;
a time of day; and
a current activity of the user.

5. The system of claim 1, wherein in obtaining contextual information related to the query, the system is operative to obtain linguistic context data comprising one or more entities/concepts included in a previous query or response in a current conversation session.

6. The system of claim 1, wherein the system is further operative to identify one or more entities/concepts included in the query.

7. The system of claim 6, wherein in obtaining contextual information related to the query, the system is operative to query a knowledge graph for properties associated with the one or more entities/concepts.

8. The system of claim 1, wherein in reformatting the query as one or more reformulations, the system is operative to reformat the query into a plurality of single-turn independent queries.

9. The system of claim 1, wherein the highest ranked reformulation is a reformulation that:
makes semantic sense;
has quality candidate results based on web intelligence; and
has candidate results associated with it that are generally consistent.

10. The system of claim 1, wherein:
the query is not context-dependent when it is determined that the highest ranked reformulation is the query in its original form; and
the query is context-dependent when it is determined that the highest ranked reformulation is one of the one or more reformulations that is not the query in its original form.

11. The system of claim 1, wherein returning the response comprises returning the highest ranked reformulation to another system responsive to an API call.

12. A method for providing query understanding, comprising:
receiving a query;
obtaining contextual information related to the query;
reformatting the query as one or more reformulations based on the contextual information;
querying a search engine with the one or more reformulations;
receiving one or more candidate results; and
returning a response to the query based on a highest ranked reformulation of the one or more reformulations.

13. The method of claim 12, wherein receiving the query comprises at least one of:
receiving a query for which context outside of the current query is needed for understanding the query; and
receiving a query that is part of a conversation session or multi-turn question, and wherein the query makes reference to an entity/concept included in a previous query or response in the conversation session.

14. The method of claim 12, wherein obtaining contextual information related to the query comprises at least one of:
obtaining linguistic context data comprising one or more entities/concepts included in a previous query or response in a current conversation session; and
obtaining physical context data related to the current conversation session, wherein physical context data includes at least one of:
user preferences;
a current location of a user;
a time of day; and
a current activity of the user.

15. The method claim 12, wherein reformatting the query as one or more reformulations comprises:
reformatting the query into a plurality of single-turn independent queries; and
including the query in its original form as one of the one or more reformulations.

16. The method of claim 15, wherein returning the response to the query based on the highest ranked reformulation of the one or more reformulations comprises:
determining whether the highest ranked reformulation is the query in its original form;
in response to determining that the highest ranked reformulation is the query in its original form, determining that the query not context-dependent; and
in response to determining that the highest ranked reformulation is not the query in its original form, determining that the query is context-dependent.

17. The method of claim 12, wherein returning the response to the query based on the highest ranked reformulation comprises at least one of:
selecting as the highest ranking reformulation a reformulation that makes semantic sense;
selecting as the highest ranking reformulation a reformulation that has quality candidate results associated with it based on web intelligence; and
selecting as the highest ranking reformulation a reformulation that has candidate results associated with it that are generally consistent.

18. The method of claim 12, wherein returning the response to the query based on a highest ranked reformulation comprises returning the highest ranking reformulation to another system responsive to an API call.

19. A computer readable storage device including computer readable instructions, which when executed by a processing unit is operable to:
receive a first query;
return a first response to the first query;
receive a second query, wherein the second query does not include contextual information that is needed to understand the intent of the query;
obtain contextual information;
reformulate the second query into one or more reformulations based on the contextual information, wherein in reformulating the second query, the device is operative to include the second query in its original form as one of the one or more reformulations;
query a search engine with the one or more reformulations of the second query;
receive a plurality of candidate results;
rank the reformulations based in part on the candidate results; and
return a second response to the second query based on a highest-ranked reformulation.

20. The computer readable storage device of claim 19, wherein in obtaining the contextual information, the device is operative to obtain at least one of:
linguistic context data comprising one or more entities/concepts included in the first query or first response;
properties of one or more one or more entities/concepts included in the first query, the first response, and the second query; and
physical context data related to the current conversation session, wherein physical context data includes at least one of:
user preferences;
a current location of a user;
a current time of day; and
a current activity of the user.
